(19) United States
(12) Patent Application Publication
(10) Pub. No.: US 2010/0149692 A1
(43) Pub. Date: Jun. 17, 2010

(54) HEAD SLIDER AND STORAGE DEVICE

(75) Inventors: Tohru FUJIMAKI, Yokohama-shi (JP); Takahiro IMAMURA, Ome-shi (JP); Hiroyuki KUBOTERA, Yamato-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/637,620

(22) Filed: Dec. 14, 2009

(30) Foreign Application Priority Data
Dec. 15, 2008 (JP) 2008-318982

(51) Int. Cl. G11B 5/60

(52) U.S. Cl. 360/235.8; G9B/5.104

(57) ABSTRACT

According to one embodiment, a head slider includes a slider main body, a front rail, and at least a pair of grooves. The slider main body defines a base surface. The front rail rises from the base surface on the air inflow side of the slider main body and defines an air bearing surface on the top surface. The grooves are each formed in the front rail and define the air outflow end closer to the air inflow side than the air outflow end of the air bearing surface. The grooves are spaced apart in the slider width direction of the slider main body.

### CROSS-REFERENCE TO RELATED APPLICATIONS

This application is based upon and claims the benefit of priority from Japanese Patent Application No. 2008-318982, filed on Dec. 15, 2008, the entire contents of which are incorporated herein by reference.

### BACKGROUND

1. Field

One embodiment of the invention relates to a head slider that is embedded in a storage device.

2. Description of the Related Art

In a hard disk drive (HDD), a magnetic disk has a surface coated with a lubricant in a predetermined film thickness. An air flow is generated on the surface of the magnetic disk due to the rotation of the magnetic disk. As a result, a flying head slider floats at a predetermined flying height above the surface of the magnetic disk. The flying head slider has a air bearing surface that faces the surface of the magnetic disk. In this state, an electromagnetic transducer device on the flying head slider writes and reads magnetic information to and from the magnetic disk. Reference may be had to, for example, Japanese Patent Application Publication (KOKAI) No. H9-204625, Japanese Patent Application Publication (KOKAI) No. 2001-503903, and Japanese Patent Application Publication (KOKAI) No. 2007-220188.

While the flying head slider is floating, the lubricant is evaporated from the surface of the magnetic disk. Lubricant molecules thus evaporated adhere to the air bearing surface. Aggregation of the lubricant molecules on the air bearing surface increases the distance between the flying head slider and the magnetic disk. This reduces the accuracy of writing or reading of magnetic information. Further, a lump of the lubricant drops from the air bearing surface on the magnetic disk, the flying head slider collides against the lump, resulting in head crash.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of an internal structure of a hard disk drive (HDD) as an example of a storage device according to an embodiment of the invention;

FIG. 2 is an exemplary schematic perspective view of a flying head slider according to a first embodiment of the invention;

FIG. 3 is an exemplary schematic plan view of the flying head slider in the first embodiment;

FIG. 4 is an exemplary graph of an air pressure specified at locations along a cross-section line D in the first embodiment;

FIG. 5 is an exemplary graph of an adherence rate of lubricant molecules specified at locations along the cross-section line D in the first embodiment;

FIG. 6 is an exemplary schematic perspective view of a flying head slider according to a second embodiment of the invention;

FIG. 7 is an exemplary schematic plan view of the flying head slider in the second embodiment;

FIG. 8 is an exemplary schematic perspective view of a flying head slider according to a third embodiment of the invention;

FIG. 9 is an exemplary schematic plan view of the flying head slider in the third embodiment;

FIG. 10 is an exemplary graph of an air pressure specified at locations along the cross-section line D;

FIG. 11 is an exemplary graph of an adherence rate of lubricant molecules specified at locations along the cross-section line D;

FIG. 12 is an exemplary graph of a decreasing rate of adherence rate of specific examples in comparison with a comparative example;

FIG. 13 is an exemplary schematic perspective view of a flying head slider according to a fourth embodiment of the invention;

FIG. 14 is an exemplary schematic plan view of the flying head slider in the fourth embodiment;

FIG. 15 is an exemplary schematic perspective view of a flying head slider according to a fifth embodiment of the invention;

FIG. 16 is an exemplary schematic plan view of the flying head slider in the fifth embodiment;

FIG. 17 is an exemplary graph of an adherence rate of lubricant molecules specified at locations along the cross-section line D; and

FIG. 18 is an exemplary graph of a decreasing rate of adherence rate of specific examples in comparison with a comparative example.

### DETAILED DESCRIPTION

Various embodiments according to the invention will be described hereinafter with reference to the accompanying drawings. In general, according to one embodiment of the invention, a head slider comprises a slider main body, a front rail, and at least a pair of grooves. The slider main body is configured to define a base surface. The front rail is configured to rise from the base surface on the air inflow side of the slider main body and define an air bearing surface on a top surface. The grooves are each configured to be formed in the front rail and define the air outflow end closer to the air inflow side than the air outflow end of the air bearing surface. The grooves are configured to be spaced apart in a slider width direction of the slider main body.

According to another embodiment of the invention, a storage device comprises a storage medium and a head slider. The head slider is configured to face the storage medium. The head slider comprises a slider main body, a front rail, and at least a pair of grooves. The slider main body is configured to define a base surface. The front rail is configured to rise from the base surface on the air inflow side of the slider main body and define an air bearing surface on a top surface. The grooves are each configured to be formed in the front rail and define the air outflow end closer to the air inflow side than the air outflow end of the air bearing surface. The grooves are configured to be spaced apart in a slider width direction of the slider main body.

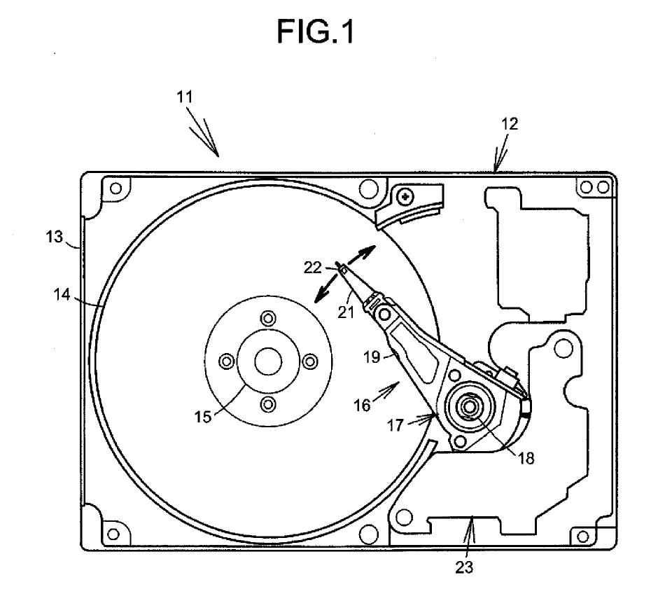

FIG. 1 schematically illustrates an internal structure of a hard disk drive (HDD) 11 as an example of a storage device according to an embodiment of the invention. The HDD 11 comprises a housing 12. The housing 12 comprises a box-shaped base 13 and a cover (not illustrated). The base 13 defines, for example, an flat rectangular internal space, i.e., a housing space. The base 13 may be formed by casting with a metal material such as aluminum (Al). The cover is connected to an opening of the base 13. The housing space is sealed between the cover and the base 13. The cover may be formed by, for example, pressing a piece of plate.

In the housing space, one or more magnetic disks 14 are housed as storage media. The magnetic disk 14 is mounted on the rotation shaft of a spindle motor 15. The spindle motor 15 can rotate the magnetic disk 14 at high speed, such as 5400 rpm, 7200 rpm, 10000 rpm, and 15000 rpm. The magnetic disk 14 may be, for example, a perpendicular magnetic recording disk. That is, in a recording magnetic film on the magnetic disk 14, the magnetization easy axis is set to be perpendicular to the surface of the magnetic disk 14.

A carriage 16 is further housed in the housing space. The carriage 16 comprises a carriage block 17. The carriage block 17 is rotatably connected to a shaft 18 that extends vertically. In the carriage block 17, a plurality of carriage arms 19 are defined that extend horizontally from the shaft 18. The carriage block 17 may be formed by, for example, extruding aluminum (Al).

Attached to the front end of each of the carriage arms 19 is a head suspension 21. The head suspension 21 extends forward from the end of the corresponding carriage arm 19. A flexure is attached to an end of the head suspension 21. In each flexure, a gimbal spring is defined. Due to the movement of the gimbal spring, a flying head slider 22 can change its posture with respect to the head suspension 21. As will be described later, on the flying head slider 22, a head device, i.e., an electromagnetic transducer device is mounted.

When an air flow is generated on a surface of the magnetic disk 14 by the rotation of the magnetic disk 14, positive pressure and negative pressure cause on the flying head slider 22 by the action of the air flow. When the positive pressure, the negative pressure, and a pressing force of the head suspension 21 are in balance, the flying head slider 22 can keep floating relatively firmly during the rotation of the magnetic disk 14.

When the carriage 16 rotates about the shaft 18 while the flying head slider 22 is floating, the flying head slider 22 can move along a radial line of the magnetic disk 14. As a result, the electromagnetic transducer device on the flying head slider 22 can traverse a data zone between the innermost recording track and the outermost recording track. Thus, the electromagnetic transducer device on the flying head slider 22 is positioned on a target recording track.

The carriage block 17 is connected to a power source such as a voice coil motor (VCM) 23. By the action of the VCM 23, the carriage block 17 can rotate about the shaft 18. Such rotation of the carriage block 17 enables swinging movement of the carriage arm 19 and the head suspension 21.

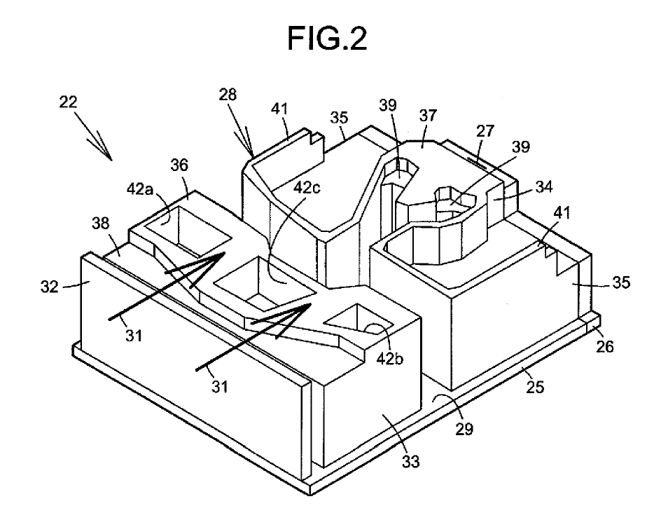

FIG. 2 is a diagram of the flying head slider 22 according to a first embodiment of the invention. The flying head slider 22 comprises a base material formed in, for example, flat rectangular parallelepiped shape, i.e., a slider main body 25. An insulated nonmagnetic film, i.e., an element containing film 26 is laminated on an air outflow side end surface of the slider main body 25. An electromagnetic transducer device 27 is embedded in the element containing film 26. The slider main body 25 is formed from a hard nonmagnetic material such as Al₂O₃—TiC (AlTiC). The element containing film 26 is formed from relatively soft insulated nonmagnetic material such as Al₂O₃ (alumina). An air bearing surface 28 of the slider main body 25 faces the magnetic disk 14. A flat base surface 29, i.e., a reference surface, is defined on the medium facing surface 28. When the magnetic disk 14 rotates, an air flow 31 flows on the medium facing surface 28 from a front end of the slider main body 25 to a rear end thereof.

A line of a wall, i.e., a skirt 32 that rises from the base surface 29 on the upstream side of the air flow 31, i.e., an air inflow side, is formed on the medium facing surface 28. The skirt 32 extends along an air inflow end of the base surface 29 in the slider width direction. The skirt 32 prevents foreign matters such as dust incoming toward the air outflow side from the skirt 32. Similarly, a line of a front rail 33 that rises from the base surface 29 on the downstream side of the air flow 31, i.e., the air outflow side of the skirt 32, is formed on the medium facing surface 28. The front rail 33 extends along the skirt 32 in the slider width direction. An air outflow end of the skirt 32 and the air inflow end of the front rail 33 are spaced apart by a predetermined distance.

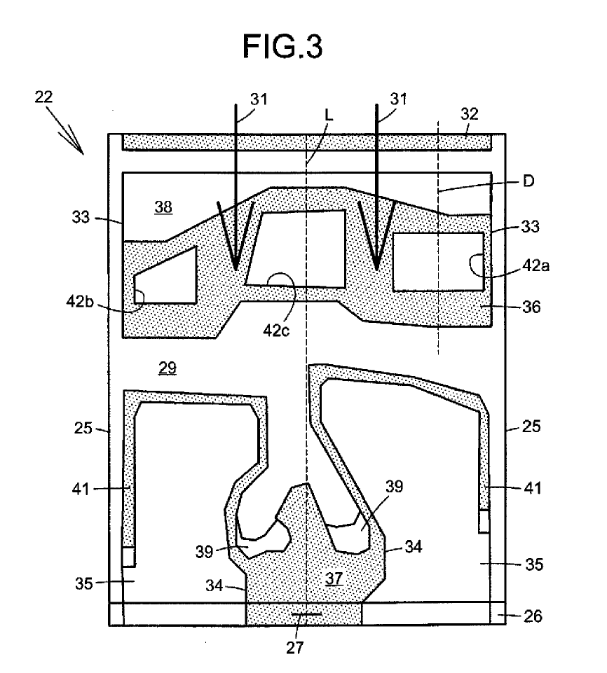

A rear center rail 34 that rises from the base surface 29 on a location closer to the air outflow side than the front rail 33 is formed on the medium facing surface 28. With reference to FIG. 3, the rear center rail 34 is positioned on a front-back direction central line L between the central point of the slider width direction defined by the air inflow end of the slider main body 25 and the central point of the slider width direction defined by the air outflow end of the slider main body 25. Similarly, a left and right pair of rear side rails 35 rises from the base surface 29 on a location closer to the air outflow side than the front rail 33. The rear center rail 34 and the rear side rails 35 reach the element containing film 26. The rear center rail 34 is located between the rear side rails 35. The rear side rails 35 are connected to the side ends of the rear center rail 34.

Air bearing surfaces (ABS) 36 and 37 are defined on the top surfaces of the front rail 33 and the rear center rail 34, respectively. The air inflow ends of the ABSs 36 and 37 are connected to step surfaces 38 and 39, respectively, with step differences therebetween. The step surfaces 38 and 39 are situated to be lower than the ABSs 36 and 37, respectively. The step surface 38 extends along the air inflow end of the front rail 33 in the slider width direction. The air flow 31 flowing thereinto causes a relatively large positive pressure applied on the ABSs 36 and 37 due to the step differences. Further, on the backside of the front rail 33, i.e., behind the front rail 33, a large negative pressure is generated. The floating posture of the flying head slider 22 is determined due to balance between the positive pressure and the negative pressure.

The air inflow ends of the rear side rails 35 are defined closer to the air inflow side than the air inflow end of the rear center rail 34. Enclosing walls 41 that extend continuously along the edges of the rear side rails 35, respectively, are formed on the rear side rails 35. The enclosing wall 41 extends at least along the air inflow end of the rear side rail 35. The rear ends of the enclosing walls 41 are connected to the rear center rail 34. The top surface of the rear side rail 35 extends at a level lower than the step surface 39. The top surface of the skirt 32, the ABSs 36 and 37, and the top surfaces of the enclosing walls 41 extend along an imaginary plane.

A pair of grooves 42a and 42b is formed on the ABS 36 of the front rail 33. The grooves 42a and 42b are spaced apart in the slider width direction with the front-back direction central line L therebetween. A groove 42c is further formed on the ABS 36 between the grooves 42a and 42b. The groove 42c may be formed, for example, on the front-back direction central line L. The air outflow ends of the grooves 42a to 42c are each defined to be closer to the air inflow side than the corresponding air outflow end of the ABS 36. The air inflow ends of the grooves 42a to 42c are each defined to be closer to the air outflow side than the corresponding air inflow end of the ABS 36. Thus, the grooves 42a to 42c are surrounded by the ABS 36. On the ABS 36, the edges of the grooves 42a to 42c are defined to be, for example, rectangular. Alternatively, the edges may be defined to be polygonal or circular. The bottom surfaces of the grooves 42a to 42c extend along an imaginary plane including the top surface of the rear side rails 35.

The electromagnetic transducer device 27 is embedded in the rear center rail 34 on the air outflow side of the ABS 37. The electromagnetic transducer device 27 comprises, for example, a reading element and a writing element, i.e., a magnetic recording head. A tunnel junction magneto-resistive effect (TuMR) element is used as the reading element. In the TuMR element, a resistance change of a tunnel junction film occurs according to a direction of the magnetic field applied from the magnetic disk 14. Information is read from the magnetic disk 14 according to the resistance change. A single-pole head is used as the writing element. The single-pole head generates a magnetic field under influence of a thin film coil pattern. Information is written to the magnetic disk 14 under the influence of the magnetic field. A reading gap of the reading element and a writing gap of the writing element of the electromagnetic transducer device 27 are present on the surface of the element containing film 26. A hard protective film may be formed on the surface of the element containing film 26 on the air outflow side of the ABS 37. The hard protective film covers the reading gap and the writing gap that are exposed on the surface of the element containing film 26. A diamond-like carbon (DLC) film may be used as the protective film.

The flying head slider 22 has a front-back direction length of 0.85 millimeter along the front-back direction central line L, a slider width of 0.70 millimeter, and a thickness of 0.23 millimeter. That is, the flying head slider 22 is configured to be what is called a FEMTO slider. A depth from the ABSs 36 and 37 to the base surface 29 is set to be in a range of 2.0 micrometers to 4.0 micrometers. A depth from the ABSs 36 and 37 to the step surfaces 38 and 39 is set to be in a range of 100 nanometers to 250 nanometers. Similarly, depths from the ABSs 36 and 37 to the top surfaces of the rear side rails 35 and to the bottoms of the grooves 42a to 42c are set to be in a range of, for example, 1.0 micrometer to 2.0 micrometers.

In the flying head slider 22, a ascending force is generated in the ABS 36 than in the ABS 37. A positive pressure and a negative pressure cause on the flying head slider 22 by the action of the air flow. The sum of a positive pressure and a negative pressure are called an air force. As a result, the slider main body 25 is maintained in a inclined posture at a pitch angle α from the balance of the ascending force and a pressing force of the head suspension 21. The pitch angle α means a inclined angle of the front-back direction of the slider main body along the flowing direction of the air flow 31. On the other hand, uniform air force is generated in the slider width direction. As a result, a fluctuation of a roll angle β is significantly suppressed. In the slider main body 25, the roll angle β is maintained at a constant value. The roll angle β means a inclined angle of the slider width direction perpendicular to the flowing direction of the air flow 31. While the inclined posture is thus defined, the writing element of the electromagnetic transducer device 27 writes binary information to the magnetic disk 14. Similarly, the reading element of the electromagnetic transducer device 27 reads binary information from the magnetic disk 14.

In the HDD 11, lubricant evaporates into the air from the surface of the magnetic disk 14. The air flow 31 makes lubricant molecules in the air adhere to the medium facing surface 28 of the flying head slider 22. The inventors has focused attention on the air molecules that are present between the magnetic disk 14 and the flying head slider 22. The air molecules collide against lubricant molecules in the air, and thus, the lubricant molecules are flicked by the collision of the air molecules. The collision against the air molecules can suppress adhesion of the lubricant molecules to the flying head slider 22. Therefore, the more air molecules are present between the magnetic disk 14 and the flying head slider 22, the more the adhesion of the lubricant molecules thereto can be suppressed. The more the air pressure between the magnetic disk 14 and the flying head slider 22 is, the more the air molecules are present therebetween. At the same time, the larger the distance between the magnetic disk 14 and the flying head slider 22 is, the more the air molecules are present therebetween. As a result, the air molecules are more likely to collide against the lubricant molecules. In addition, the smaller the area of the ABS 36 is, the smaller the number of the lubricant molecules that adhere to the ABS 36 is.

The inventors examined the effect of the first embodiment based on a simulation. Flying head sliders for in a specific example 1 and a comparative example 1 were prepared for the simulation. The flying head slider 22 was used for the specific example 1. The flying head slider in which the grooves 42a to 42c were not formed was used for the comparative example 1. As a result, the area of the ABS 36 in the comparative example 1 was larger than the area of the ABS 36 in the specific example 1. The revolution speed of the magnetic disk 14 was set to 10000 rpm. The floating amount of the flying head slider 22 was set to 8.5 nanometers. A pitch angle α was set to 140 microradians. A skew angle was set to 5 degrees. The same floating posture was defined in the specific example 1 and the comparative example 1. A distribution was calculated of air pressures specified between the flying head slider 22 and the magnetic disk 14 at locations along a cross-section line D illustrated in FIG. 3.

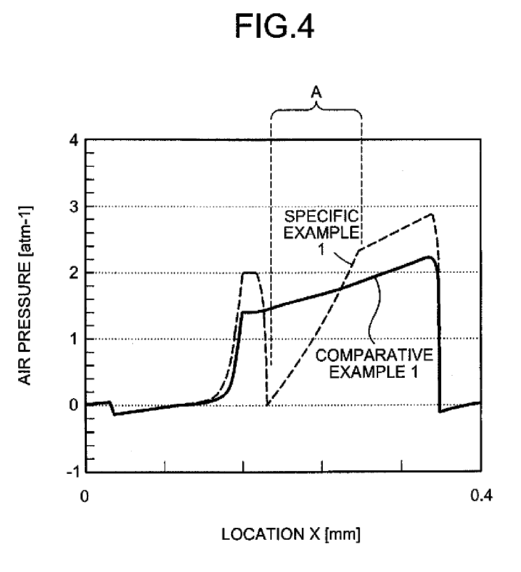

FIG. 4 is a graph of distribution of air pressures calculated at locations X specified along the cross-section line D. The horizontal axis represents a distance [millimeter] from the air inflow end of the flying head slider 22 “0” to a location X. The vertical axis represents an air pressure [atm] in the interior of the HDD 11. A pressure on the vertical axis indicates an air pressure that is obtained by subtracting 1 atm from the calculated air pressure. That is, the atmospheric pressure (1 atm) was assumed to be the reference zero. In the comparative example 1, a pressure increased abruptly at the air inflow end of the ABS 36. Then, the air pressure gradually increased from the air inflow end of the ABS 36 to the air outflow end thereof. On the other hand, in the specific example 1, the air pressure abruptly decreased at the air inflow end of the groove 42a. In a formation area A of the groove 42a, the air pressure is smaller than that in the comparative example 1. At locations closer to the air inflow side than or closer to the air outflow side than the groove 42a, however, the air pressure is larger than in the comparative example 1.

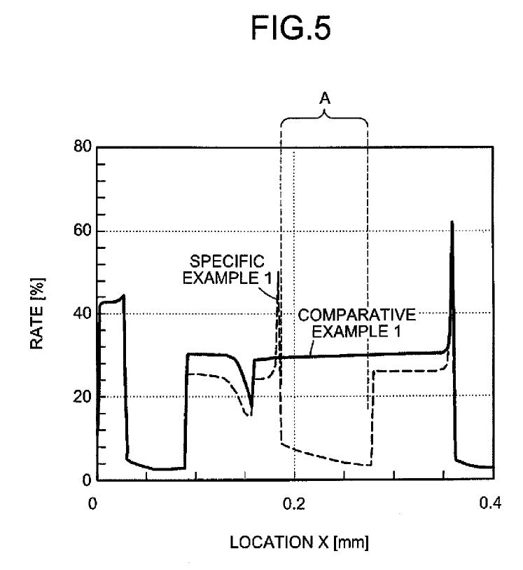

FIG. 5 is a graph of distribution of suppression rates of lubricant molecule adhesion calculated at locations X specified along the cross-section line D. The vertical axis represents a rate [percent] of an adherence rate [nanometer/hour] of the lubricant molecules not considering the presence of the air molecules to an adherence rate [nanometer/hour] of the lubricant molecules considering the presence of the air molecules. The smaller the rate is, the more the adhesion of the lubricant molecules is suppressed. The effect of the air molecules are not considered in a situation, for example, where the air pressure is zero, or where the distance between the magnetic disk 14 and the flying head slider 22 is zero. An adherence rate is expressed in a film thickness of the lubricant molecules that adhere to the flying head slider 22 per unit time.

As a result, the rate in the formation area A of the groove 42a significantly increased in the specific example 1. It can be understood that the result is attributed to the increased distance between the magnetic disk 14 and the flying head slider 22 despite the decreased air pressure in the formation area A. On the other hand, the rate increased at the locations closer to the air inflow side and the air outflow side of the ABS 36 than the groove 42a. It can be understood that the result is attributed to the air pressures applied at the locations closer to the air inflow side and the air outflow side than the groove 42a that were larger than those in the comparative example 1. Thus, it was verified that less lubricant molecules adhere to the ABS 36 in the specific example 1 than in the comparative example 1.

In the flying head slider 22, the grooves 42a to 42c are formed on the ABS 36. As a result, the distance between the bottom surfaces of the grooves 42a to 42c and the magnetic disk 14 are larger than those in a flying head slider in which the grooves 42a to 42c are not formed. Further, the air flow 31 accumulated in the grooves 42a to 42c are received by the ABS 36 that is located closer to the air outflow side than the grooves 42a to 42c. As a result, the air pressure is larger at the locations closer to the air outflow side than the grooves 42a to 42c. In addition, because the grooves 42a to 42c are formed, the area of the ABS 36 is smaller than in that the flying head slider in which the grooves 42a to 42c are not formed thereon. Because of the three factors, the adhesion of the lubricant molecules to the flying head slider 22 is suppressed. Further, a pair of the grooves 42a and 42b is disposed on the ABS 36 so that the front-back direction central line L is between the grooves 42a and 42b. The ascending force is larger on a location closer to the air outflow side than the grooves 42a and 42b. Preferable balance of the ascending force is achieved in the slider width direction. Thus, the flying head slider 22 can float stably.

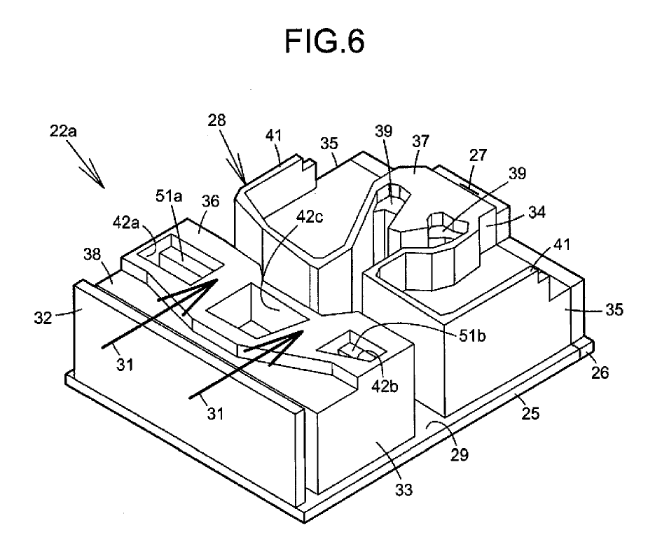

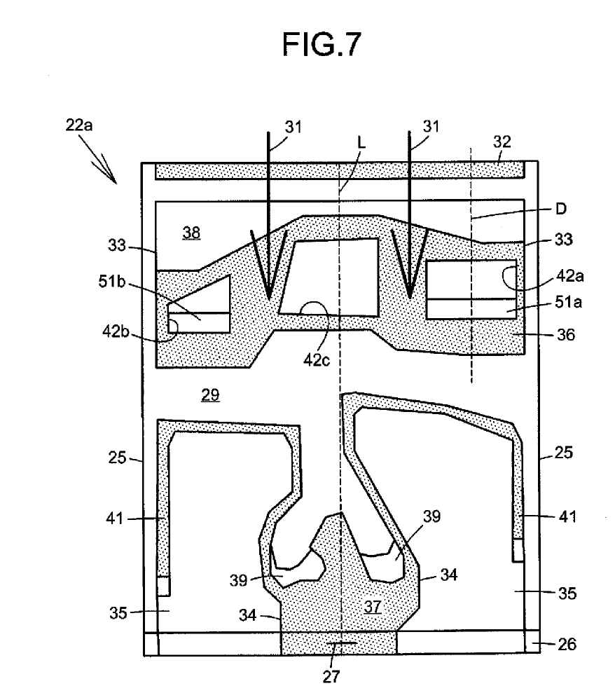

FIG. 6 is a diagram of a flying head slider 22a according to a second embodiment of the invention. The same reference numerals refer to constituent elements and structures corresponding to those of the flying head slider 22. In the flying head slider 22a, lower level surfaces 51a and 51b are respectively formed in the grooves 42a and 42b. The lower level surfaces 51a and 51b extend at a level lower than the ABS 36. With reference to FIG. 7, the lower level surfaces 51a and 51b are connected to the ABS 36 on the air outflow side in the grooves 42a and 42b with step differences therebetween. The lower level surfaces 51a and 51b are defined to be parallel to an imaginary plane including the ABS 36. The depth from the ABS 36 to the lower level surfaces 51a and 51b is set to be the same as the depth from the ABS 36 to the step surface 38.

With the flying head slider 22a, the same effect can be achieved as with the flying head slider 22. In addition, in the flying head slider 22a, the lower level surfaces 51a and 51b are defined that are connected to the ABS 36 on the air outflow side in the grooves 42a and 42b with step differences therebetween. As a result, the air flow 31 accumulated in the grooves 42a and 42b is applied to the ABS 36 due to the step differences defined between the lower level surfaces 51a and 51b and the ABS 36. As a result, still larger ascending force is generated on the ABS 36 that is located closer to the air outflow side than the grooves 42a and 42b, compared with the flying head slider 22. As a result, the adhesion of the lubricant molecules to the ABS 36, i.e., the flying head slider 22a can be suppressed.

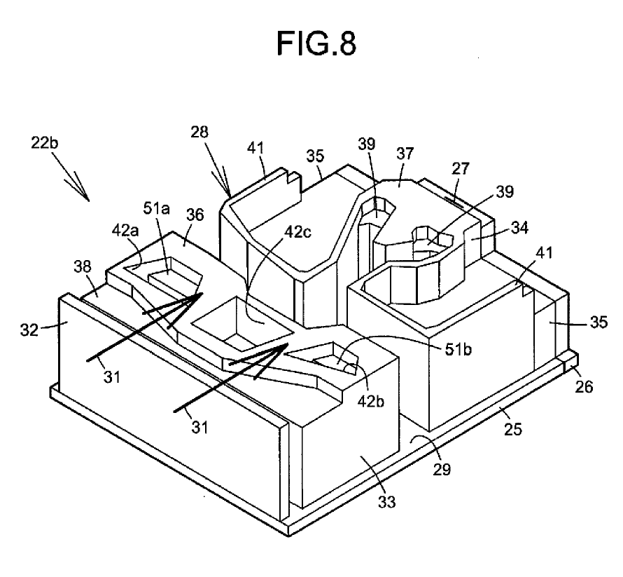

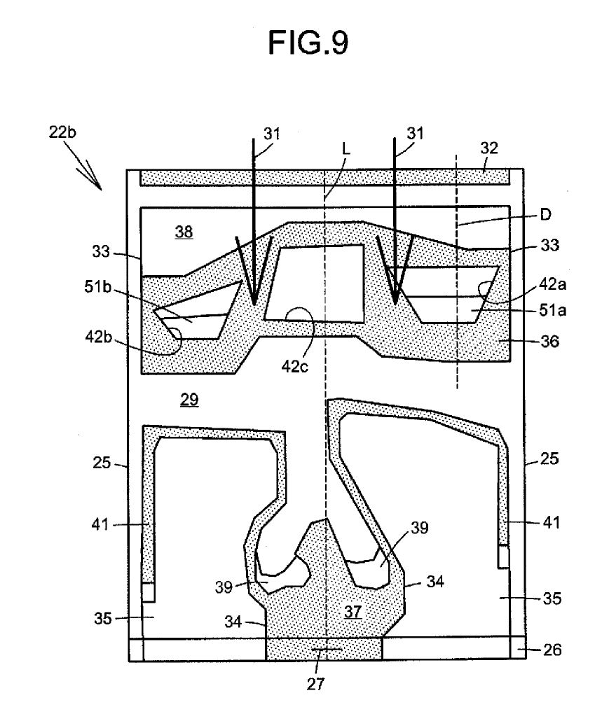

FIG. 8 is a diagram of a flying head slider 22b according to a third embodiment of the invention. The same reference numerals refer to constituent elements and structures corresponding to those of the flying head sliders 22 and 22a. In the flying head slider 22b, widths of the grooves 42a and 42b defined in the slider width direction on the air inflow side are set to be larger than widths of the grooves 42a and 42b defined in the slider width direction on the air outflow side. With reference to FIG. 9, the widths of the grooves 42a and 42b defined in the slider width direction gradually decrease from the air inflow end thereof to the air outflow end thereof. The air inflow ends or the air outflow ends of the grooves 42a to 42c are not necessarily defined to be perpendicular to the front-back direction central line L.

With the flying head slider 22b, the same effect can be achieved as with the flying head sliders 22 and 22a. In addition, in the grooves 42a and 42b, the width at the air outflow end is smaller than the width at the air inflow end. Therefore, the density of the air flow 31 that flows from the air inflow ends of the grooves 42a and 42b to the grooves 42a and 42b increases at the air outflow ends of the grooves 42a and 42b. As a result, still larger ascending force is generated on the ABS 36 that is located closer to the air outflow side than the grooves 42a and 42b, compared with the flying head sliders 22 and 22a. The adhesion of the lubricant molecules to the ABS 36, i.e., the flying head slider 22b can be further suppressed.

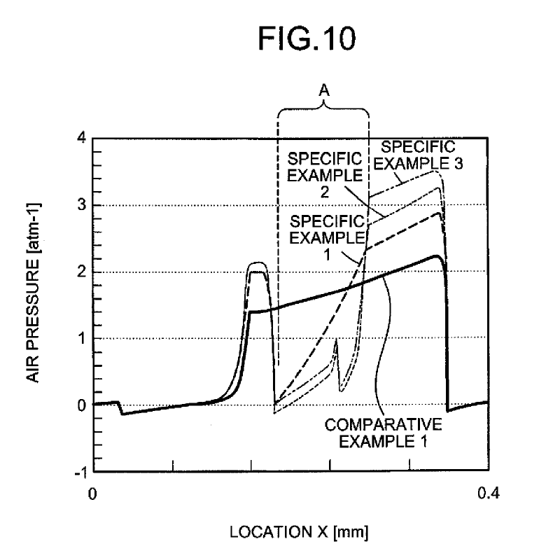

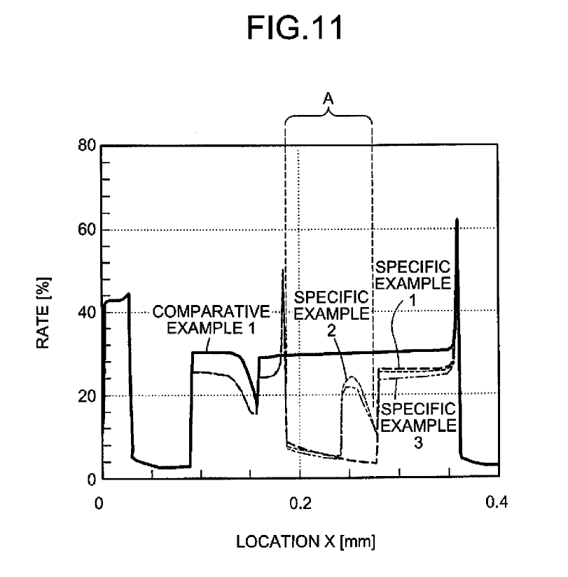

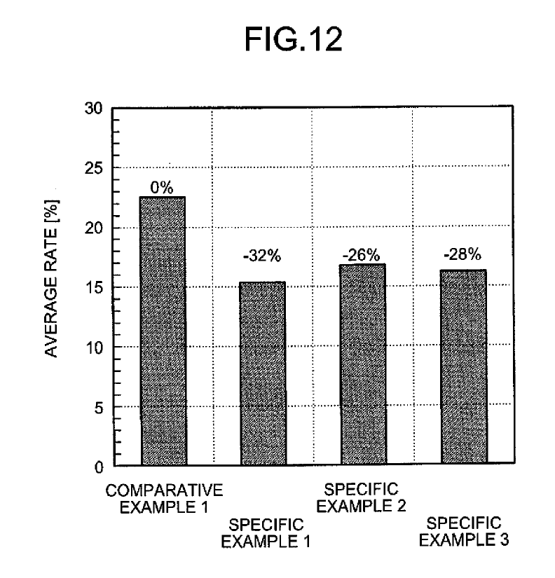

The inventors also examined the effect of the second and third embodiments based on a simulation. Specific examples 2 and 3 were prepared in addition to the specific example 1 and the comparative example 1 for the simulation. The flying head sliders 22a and 22b are used for the specific examples 2 and 3, respectively. The simulation was performed in the same conditions as previously described. As a result, as illustrated in FIG. 10, in the specific example 2, still larger ascending force was generated on a portion closer to the air outflow side than the groove 42a compared to the specific example 1. Similarly, in the specific example 3, a still larger ascending force was generated on the portion closer to the air outflow side than the groove 42a compared to the specific example 2. On the other hand, as illustrated in FIG. 11, in the specific examples 2 and 3, a more preferable rate was calculated at the lower level surfaces 51a and 51b than in the comparative example 1, although the rate was slightly inferior to that in the specific example 1. At the same time, because of the larger air pressure, the rate at the ABS 36 that was located closer to the air outflow side than the groove 42a was still more enhanced than in the specific example 1. Therefore, it was verified that still less lubricant molecules adhered to the ABS 36 in the specific examples 2 and 3 than in the specific example 1. FIG. 12 is a graph of average values of the rates in the specific examples 1 to 3 and the comparative example 1. It was verified that the rates in the specific examples 1 to 3 were enhanced by about 30 percent in comparison with those in the comparative example 1.

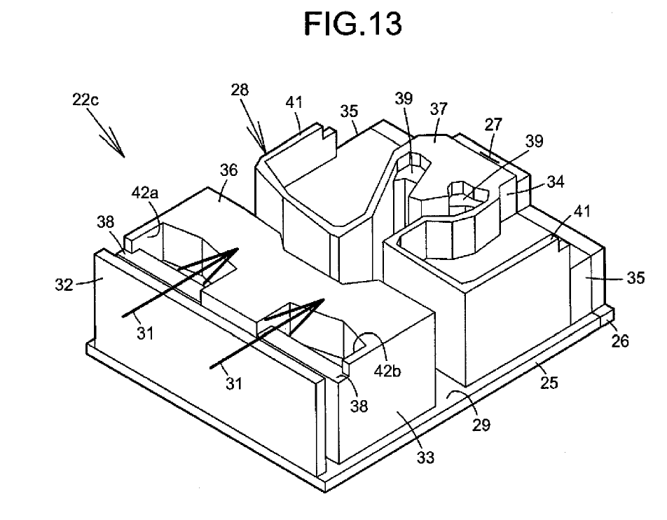

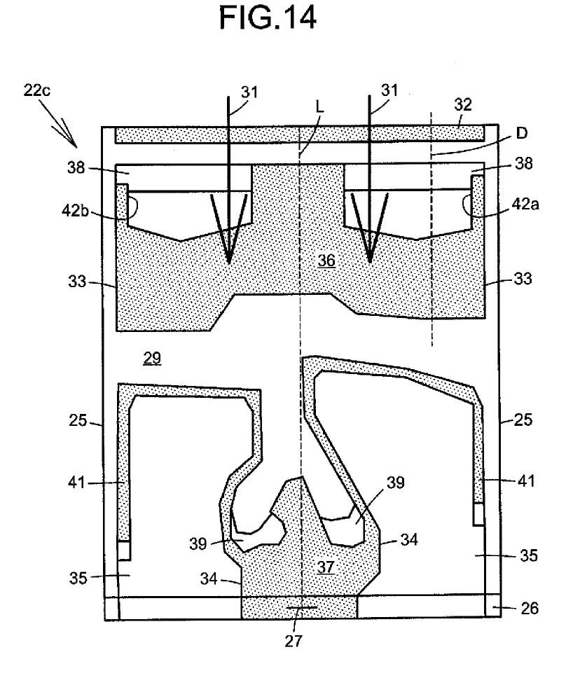

FIG. 13 is a diagram of a flying head slider 22c according to a fourth embodiment of the invention. The same reference numerals refer to constituent elements and structures corresponding to those of the flying head slider 22. In the flying head slider 22c, the grooves 42a and 42b are formed along the air inflow end of the ABS 36. The air outflow ends of the grooves 42a and 42b are connected to the air inflow end of the ABS 36. At the same time, the air inflow ends of the grooves 42a and 42b are connected to the step surface 38. In the embodiment, the step surface 38 is divided into two by the ABS 36 at the central position of the step surface 38. Thus, the grooves 42a and 42b are surrounded by the ABS 36 and the step surface 38. With reference to FIG. 14, the contours of the grooves 42a and 42b may be defined to be left-right symmetric about the front-back direction central line L. The groove 42c is not formed on the ABS 36.

With the flying head slider 22c, the distance between the bottom surfaces of the grooves 42a and 42b and the magnetic disk 14 is still larger. The air flow 31 accumulated in the grooves 42a and 42b is applied on the ABS 36 that is located closer to the air outflow side than the grooves 42a and 42b. As a result, ascending force is larger on the ABS 36 that is located closer to the air outflow side than the grooves 42a and 42b. In addition, the area of the ABS 36 is smaller because of the grooves 42a and 42b formed thereon. Because of the three factors, the adhesion of the lubricant molecules to the ABS 36, i.e., the flying head slider 22c is suppressed. Further, a pair of the grooves 42a and 42b is disposed on the ABS 36 so that the front-back direction central line L is between the portions. The ascending force is larger on the portion closer to the air outflow side than the grooves 42a and 42b. Preferable balance of the positive pressure is achieved in the slider width direction. Thus, the flying head slider 22c can float stably.

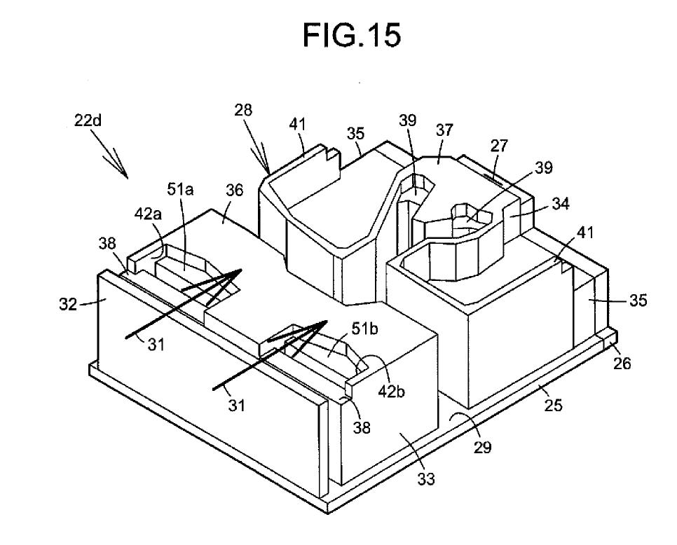

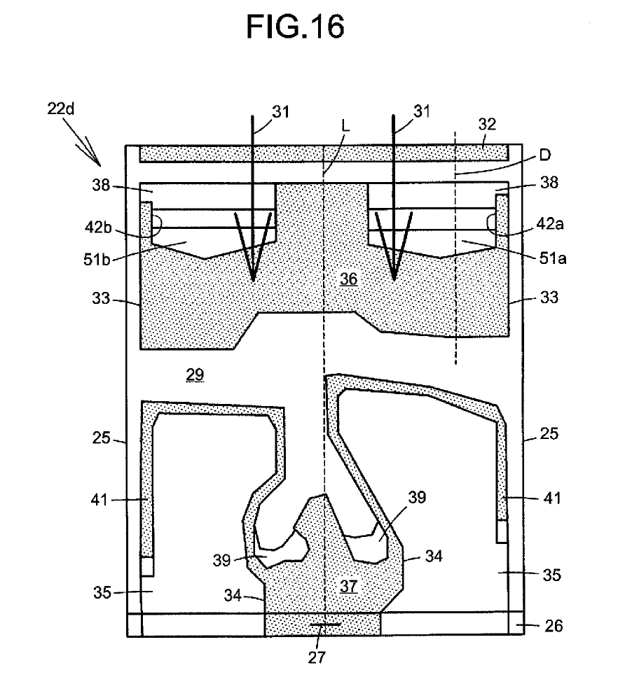

FIG. 15 is a diagram of a flying head slider 22d according to a fifth embodiment of the invention. The same reference numerals refer to constituent elements and structures corresponding to those of the flying head sliders 22 to 22c. In the flying head slider 22d, the lower level surfaces 51a and 51b are respectively formed in the grooves 42a and 42c. With reference to FIG. 16, the lower level surfaces 51a and 51b extend along the air outflow ends of the grooves 42a and 42b. With the flying head slider 22d, the same effect can be achieved as with the flying head slider 22c. In addition, a still larger ascending force is applied on the ABS 36 due to the step differences defined between the lower level surfaces 51a and 51b and the ABS 36, compared with the flying head slider 22c. As a result, the adhesion of the lubricant molecules to the ABS 36, i.e., the flying head slider 22d can be further suppressed.

The inventors also examined the effect of the fourth and fifth embodiments based on a simulation. The flying head sliders used for specific examples 4 and 5 and a comparative example 2 were prepared in the HDD 11 for the simulation. The flying head sliders 22c and 22d were used for the specific examples 4 and 5, respectively. The flying head slider 22c in which the grooves 42a and 42b were not formed was used for the comparative example 2. The formation areas of the grooves 42a and 42b were defined by the step surfaces 38. As a result, the area of the ABS 36 in the comparative example 2 was set to be the same as the area of the ABS 36 in the specific examples 4 and 5. In the HDD 11, the revolution speed of the magnetic disk 14 was set to 10000 rpm. The floating amount of the flying head slider 22 was set to 9.3 nanometers. A pitch angle α was set to 121 microradians. A skew angle was set to 5 degrees. The same floating posture was defined in the specific examples 4 and 5, and the comparative example 2.

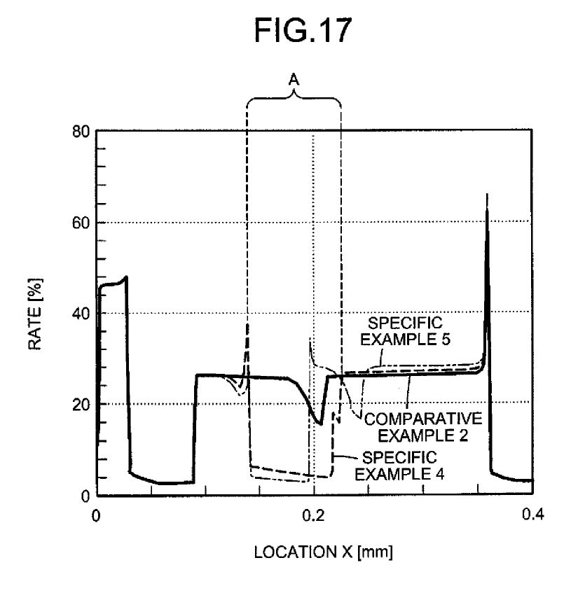

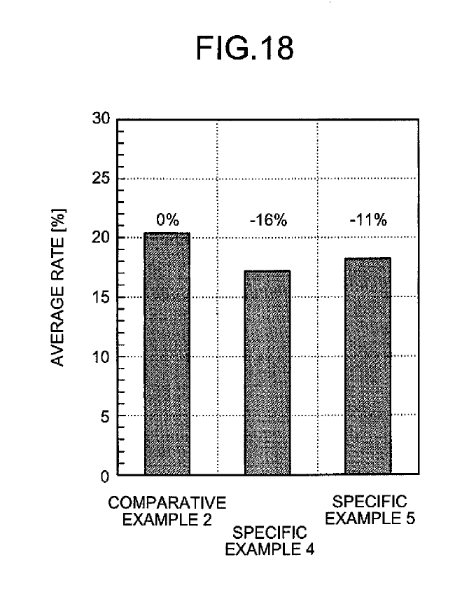

A distribution was calculated of decreasing rates of the adhesion of the lubricant molecules along the cross-section line D. As a result, as illustrated in FIG. 17, in the specific examples 4 and 5, more preferable rates were calculated in the formation area A of the groove 42a, compare with the comparative example 2. It can be understood that the result is attributed to the increased distance between the magnetic disk 14 and the groove 42a despite the decreased air pressure in the formation area A. On the other hand, in the specific example 5, the rate is partially significantly enhanced on the ABS 36 that is located closer to the air outflow side than the groove 42, although the rate is inferior to that of the comparative example 2 because the distance from the magnetic disk 14 is smaller due to the lower level surface 51a. Thus, it was verified that less lubricant molecules adhered to the ABS 36 in the specific examples 4 and 5, than in the comparative example 2. FIG. 18 is a graph of average values of the rates in the specific examples 4 and 5 and the comparative example 2. It was verified that the rates were enhanced by about 15 percent in the specific examples 4 and 5 in comparison with that in the comparative example 2.

Modifications of the embodiments will be described. In the flying head sliders 22 to 22d, the depth from the ABS 36 to the bottom surfaces of the grooves 42a to 42c may be set to be the same as that from the ABS 36 to the base surface 29. Then, the depth from the ABS 36 to the lower level surfaces 51a and 51b may be set to be the same as that from the ABS 37 to the top surface of the rear side rail 35. Similarly, the depth from the ABS 36 to the bottom surfaces of the grooves 42a to 42c may be set to be the same as that from the ABS 36 to the step surface 38. In the grooves 42a and 42b of the flying head sliders 22c and 22d, the width on the air inflow end may be set to be larger than that on the air outflow end. In the flying head slider 22b, the lower level surfaces 51a and 51b may not be formed. In the flying head sliders 22 to 22d, the grooves 42a and 42b may be opened on the side ends of the front rail 33.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head slider comprising:
a slider main body comprising a base surface;
a front rail on the base surface at an air inflow side of the slider main body configured to define an air bearing surface on a top surface; and
at least a pair of grooves in the front rail comprising an air outlet closer to the air inflow side than an air outlet of the air bearing surface, the grooves being apart in a width direction of the slider main body.

2. The head slider of claim 1, wherein a width of an air inlet the grooves in the width direction of the slider main body is larger than a width of the air outlet of the grooves in the width direction.

3. The head slider of claim 1, further comprising a step surface on an air inlet of the front rail lower than the air bearing surface, and extending higher than bottom surfaces of the grooves, the step surface being connected to the air bearing surface with a step difference.

4. The head slider of claim 3, wherein
the air outlets of the grooves are connected to an air inlet of the air bearing surface, and
the air inlets of the grooves are connected to an air outlet of the step surface.

5. The head slider of claims 1, further comprising a lower level surface extending at a level lower than the air bearing surface on an air outflow side of the grooves, and being connected to the air bearing surface with a step difference.

6. A storage device comprising:
a storage medium; and
a head slider facing the storage medium, the head slider comprising
a slider main body comprising a base surface;
a front rail on the base surface at an air inflow side of the slider main body configured to define an air bearing surface on a top surface; and
at least a pair of grooves in the front rail comprising an air outlet closer to the air inflow side than an air outlet of the air bearing surface, the grooves being apart in a width direction of the slider main body.
